(19) United States
(12) Patent Application Publication
(10) Pub. No.: US 2023/0172357 A1
(43) Pub. Date: Jun. 8, 2023

(54) MASSAGING APPARATUS CONVERTIBLE USAGE STATUS

(71) Applicant: CERAGEM Co., Ltd., Cheonan-si (KR)

(72) Inventors: Su Hyun Kim, Cheonan-si (KR); Sang Ho Choi, Cheonan-si (KR); Dong Myoung Lee, Asan-si (KR); Seung Jong Lee, Cheongju-si (KR)

(21) Appl. No.: 18/059,912

(22) Filed: Nov. 29, 2022

(30) Foreign Application Priority Data
Dec. 2, 2021 (KR) 10-2021-0171053

(51) Int. Cl. A47C 3/20; A61H 7/00

(52) U.S. Cl. CPC A47C 3/20; A61H 7/007; A61H 2201/0149; A61H 2205/081; A61H 2205/10

(57) ABSTRACT

A use state-switchable massage device includes a backrest part and a seat part. In the use state-switchable massage device, the use state can be switched so that a user may perform a massage while sitting (sitting-mode) or lying down (lying-mode). When the use state is switched from the sitting state to the lying state, the massage may be performed in a state in which the user's waist is fully stretched (a state in which the spine is straightened while being curved upward).

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to a use state-switchable massage device. More specifically, the present disclosure relates to a use state-switchable massage device, in which the use state can be switched so that a user may perform a massage while sitting (sitting-mode) or lying down (lying-mode), wherein when the use state is switched from the sitting state to the lying state, the massage may be performed in a state in which the user's waist is fully stretched (a state in which the spine is straightened while being curved upward).

### Related Technology

In order to ease acute or chronic pain occurring in muscles and nervous tissues of a spine region due to continuous work in an improper posture for a long time or habituation of such a posture for a long time, to improve blood circulation in the body, or to relieve momentary muscle stiffness, a massage device which moves along body parts and improves blood circulation by stimulating a pain-producing part with heat has been widely used.

Korean Patent Laid-Open Publication No. 2012-0118398 and Korean Registered Utility Model Publication No. 0477442 disclose the related technology. The disclosure of this section is to provide background information relating to the present disclosure. Applicant does not admit that any information contained in this section constitutes prior art.

### SUMMARY

Aspects of the present disclosure provide a use state-switchable massage device, in which the use state can be switched so that a user may perform a massage while sitting (sitting-mode) or lying down (lying-mode), wherein when the use state is switched from the sitting state to the lying state, the massage may be performed in a state in which the user's waist is fully stretched (a state in which the spine is straightened while being curved upward).

The technical tasks provided in the present disclosure are not limited thereto, and other technical tasks not mentioned will be clearly understood by those skilled in the art from the following description.

Aspects of the present disclosure provide a use state-switchable massage device comprising: a backrest part having a first support surface for supporting a user's upper body, and a massage module for massaging the user's upper body while moving along the first support surface, wherein the backrest part is rotatable so as to be switched between a first state in which the user is sitting and a second state in which the user is lying down; and a seat part having a second support surface for supporting the user's lower body; wherein the massage module is configured to massage the user's upper body in the case of the first state and to massage the user's upper and lower body in the case of the second state; wherein the backrest part includes an extension member formed to extend along the first support surface so that the massage module moves to the user's lower body in the case of the second state; and wherein the seat part includes an insertion groove into which the extension member is inserted in the case of the second state.

Here, in the case of the first state, the first support surface and the second support surface may be arranged to be inclined so as to form a first slope with each other, and in the case of the second state, the first support surface and the second support surface may be arranged on the same line.

Each of the backrest part and the extension member may be provided with a rail member extending along a moving direction of the massage module.

The massage device may further include a hinge part for hingedly fixing the backrest part so that the backrest part can rotate about a hinge point spaced upward from the second support surface.

The hinge part may include: a first support bar extending upward from the second support surface so that the hinge point is disposed at a position spaced upward therefrom; and a second support bar connecting the hinge point and the backrest part so that the backrest part can rotate about the hinge point.

The hinge part may include a first guide bar provided in the backrest part and a first guide plate provided in the seat part and having a first guide hole providing a movement path of the first guide bar, wherein the first guide hole may be configured to have the same curvature as a concentric circle centered on the hinge point.

The massage device may further include a tilting part for rotating the seat part so that a second slope is formed on the seat part.

In the case of the first state, the tilting part may rotate the seat part so that the rear of the seat part is positioned at a lower position than the front of the seat part and thus the seat part is inclined upward; and in the case of the second state, the tilting part may rotate the seat part so that the front and rear portions of the seat part are positioned at the same height, and thus the seat part is horizontally arranged.

The tilting part may include a second guide bar provided at the rear of the seat part and a second guide plate provided with a second guide hole providing a movement path of the second guide bar, wherein the second guide hole may be formed along a height direction so that the rear of the seat part moves in the height direction.

The tilting part may include a third guide bar provided at the front of the seat part and a third guide plate provided with a third guide hole providing a movement path for the third guide bar; a fourth guide bar provided at the rear of the seat part; and a fourth guide plate provided with a fourth guide hole providing a movement path for the fourth guide bar; wherein the third guide hole may be formed along an front-rear direction so that the front of the seat part moves in the front-rear direction; and wherein the fourth guide hole may be formed along the height and front-rear directions so that the rear of the seat part moves in the height and front-rear directions.

In the process of rotating the backrest part to switch from the first state to the second state, the lower end of the backrest part may move upward while lifting the rear end of the seat part so that the seat part is arranged horizontally.

The lower end of the backrest part may be provided with a locking member supporting the rear end of the seat part in the second state.

The seat part may include a cover member supporting the user's lower body to prevent it from falling into the insertion groove in the first state.

According to the use state-switchable massage device according to the present disclosure having the configuration as described above, in the process of rotating the backrest part to switch the use state from the first state to the second state, the extension member formed to extend from the backrest part is inserted into the insertion groove of the seat part, and thus interference between the backrest part and the seat part does not occur. Therefore, since the backrest part and the seat part can be completely unfolded so that the user's waist is fully stretched, chiropractic and a traction operation to lift the user's spine are performed by the massage module, thereby maximizing a massage effect. Further, in the first state, since the extension member formed to extend from the backrest part is positioned below the seat part in the height direction, the position of the center of gravity of the massage device is lowered in the first state, and thus structural stability can be secured. In addition, since the rest of the backrest part excluding the extension member only needs to support the user's upper body (cervical spine, thoracic spine, and lumbar spine), the length of the backrest part is shortened, and thus the rotation radius of the upper end of the backrest part is reduced, whereby movement of the center of gravity of the massage device is minimized in the process of switching from the first state to the second state, so that structural stability can be secured.

Further, in the first state, the first support surface provided on the backrest part and the second support surface provided on the seat part are arranged to form a first slope so that the user can sit in a comfortable posture and receive a massage; and in the second state, the first support surface and the second support surface are arranged on the same line so that the user's waist is fully stretched, whereby chiropractic and a traction operation to lift the user's spine are performed by the massage module, thereby maximizing a massage effect.

In addition, the backrest part and the extension member are arranged to be connected to each other in a state where the rail members are respectively provided therein, or an integral rail member is disposed on the backrest part and the extension member, whereby the massage module can perform continuous massage from the cervical spine to the sacral vertebrae in the second state; and the user's satisfaction is improved by removing a sense of heterogeneity which may be felt in the process of moving the massage module to the extension member. Further, in the second state, since the rail member provided in the extension member is inserted into the insertion groove and thus, a reference position, which is a position in the height direction of the massage module, becomes constant, it is easy to control the position in the height direction of thermal ceramics provided in the massage module even when said position of the thermal ceramics needs to be adjusted for customized massage according to the user's body shape; and it is easy to design a mechanism such as a guide rail for raising the thermal ceramics.

In addition, by providing the hinge part so that the hinge point serving as the central axis of rotation of the backrest part is formed at a position spaced upward from the second support surface of the seat part, the state in which the first support surface supports the user's upper body is maintained constant even when the backrest part is rotated in the process of switching the use state from the first state to the second state, and therefore, the user's satisfaction is improved by eliminating the inconvenience that may be felt when the use state is switched.

In addition, the backrest part can be stably rotated in a state where the hinge point is disposed at a position spaced upward from the second support surface by the first support bar and the second support bar.

In addition, the first guide hole provided in the first guide plate so that the backrest part rotates around a virtual hinge point is formed to have the same curvature as a concentric circle centered on the virtual hinge point; and the backrest part rotates while the first guide bar provided in the backrest part moves along the first guide hole, whereby the user does not feel uncomfortable when the backrest part is rotated to change the use state.

In addition, the seat part is configured to be rotatable by the tilting part, so that the user can receive a massage in a comfortable posture suitable for a sitting state or a lying state in which the user uses.

In addition, since the seat part is configured to be movable in the front-rear direction, even if the user's lower body is moved forward and backward by the backrest part in the process of switching the use state, the user's lower body can be stably supported by the seat part.

It should be understood that the effects of the present disclosure are not limited to the above effects, and include all effects that can be inferred from the configuration of the disclosure described in the detailed description or claims of the present disclosure.

### BRIEF DESCRIPTION OF THE DRAWINGS

FIGS. 1 and 2 are a side view and a plan view, respectively, showing a use state-switchable massage device according to an embodiment of the present disclosure in a sitting state in which a user sits and uses it.

FIGS. 3 and 4 are a side view and a plan view, respectively, showing a use state-switchable massage device according to an embodiment of the present disclosure in a lying state in which a user lies down and uses it.

FIG. 5 is a side view showing a use state-switchable massage device according to another embodiment of the present disclosure in a sitting state in which a user sits and uses it.

FIG. 6 is a side view showing a use state-switchable massage device according to another embodiment of the present disclosure in a lying state in which a user lies down and uses it.

FIG. 7 is a side view showing a use state-switchable massage device according to still another embodiment of the present disclosure in a sitting state in which a user sits and uses it (seat part is rotated).

FIG. 8 is a side view showing a use state-switchable massage device according to still another embodiment of the present disclosure in a lying state in which a user lies down and uses it (seat part is rotated).

FIG. 9 is a side view showing a use state-switchable massage device according to still another embodiment of the present disclosure in a sitting state in which a user sits and uses it (seat part is rotated and moved forward).

FIG. 10 is a side view showing a use state-switchable massage device according to still another embodiment of the present disclosure in a lying state in which a user lies down and uses it (seat part is rotated and moved forward).

FIGS. 11 and 12 are side views illustrating various embodiments of a fourth guide plate provided in a use state-switchable massage device according to still another embodiment of the present disclosure.

FIG. 13 is a perspective view showing a use state-switchable massage device according to still another embodiment of the present disclosure in a lying state in which a user lies down and uses it (structure in which the backrest part lifts the seat part).

FIG. 14 is a plan view illustrating a cover member provided in a use state-switchable massage device according to still another embodiment of the present disclosure.

### DETAILED DESCRIPTION OF EMBODIMENTS

Hereinafter, with reference to the accompanying drawings, embodiments of the present disclosure will be described in detail so as to be easily implemented by one of ordinary skill in the art to which the present disclosure pertains. The present invention may be embodied in a variety of forms and is not limited to the embodiments described herein. In order to clearly describe the present disclosure in the drawing, parts irrelevant to the description are omitted from the drawings; and throughout the specification, same or similar components are referred to as like reference numerals.

In the specification, terms such as “comprise” or “have” are intended to designate that a feature, number, step, operation, component, part or combination thereof described in the specification is present, but should not be construed to preclude the possibility of the presence or addition of one or more other features, numbers, steps, operations, components, parts or combinations thereof. In addition, when a part such as a layer, film, region, plate, etc. is said to be “on” another part, this includes not only the case where the part is “directly on” the another part, but also the case where there is still another part between them. Conversely, when a part such as a layer, film, region, plate, etc. is said to be “under” another part, this includes not only the case where the part is “directly under” the another part, but also the case where there is still another part between them.

In a first example, a massage device includes a body equipped with a thermal treatment unit, and a lower bed member that changes the length of the entire device while being deployed or overlapped in a sliding manner from the body. That is, the device is used in such a way that the user lies on the body (supporting human upper body) and the lower bed member (supporting human lower body) after the lower bed member is deployed(sitting-mode), or the user sits on the lower bed member when the lower bed member is overlapped with the upper part of the body(lying-mode). When the massage device is used in the lying-mode as described above, the body and the lower bed member are arranged side by side with the angle between them forming 180°. Therefore, since the user can lie down in a state in which the waist is fully stretched (a state in which the spine is straightened while being curved upward), chiropractic and a traction operation to lift the user's spine can be performed by the thermal treatment device during the massage process. However, when used in the sitting-mode, the lower bed member is disposed on the upper part of the body. Therefore, there is a limitation in that only stimulation by heat through the heating device provided in the lower bed member can be provided without using the thermal treatment device provided in the body.

In a second example, a massage chair includes a back part supporting the user's upper body and a chair part supporting the lower body, wherein the back part has an extension portion extending to the lower portion of the chair part. The back part is provided with an inner rail along which the massage unit moves, so that the user's upper body is massaged in a sitting state in which the user is sitting on the chair part, and the user's upper body and lower body are massaged in a lying state where the user is lying obliquely. To this end, the flat plate provided in the chair part is formed to have a groove through which the massage unit passes. In this case, in order to maximize the massage effect in the lying state, the user's spine should be pulled while lifting the waist in a state in which it is fully stretched (a state in which the spine is straightened while being curved upward). However, as described above, the groove formed in the flat plate is configured so that only the massage unit can pass therethrough, whereby when the back part is rotated and converted to the lying state, the back part can be rotated only to the extent that interference does not occur between the extension portion provided in the back part and the chair part. Therefore, the angle formed between the back part and the chair part is inevitably smaller than 180°, and in this state, the user's waist is not completely straightened, resulting in a reduced massage effect.

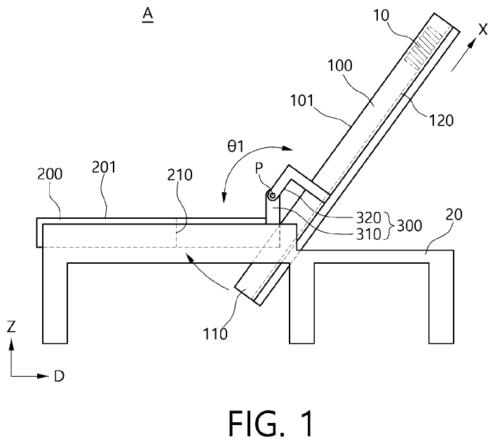

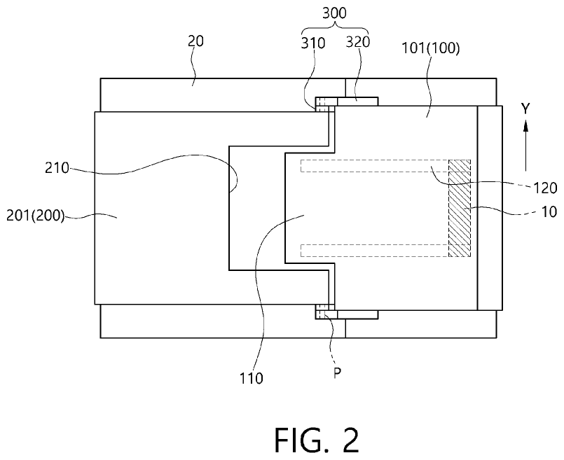

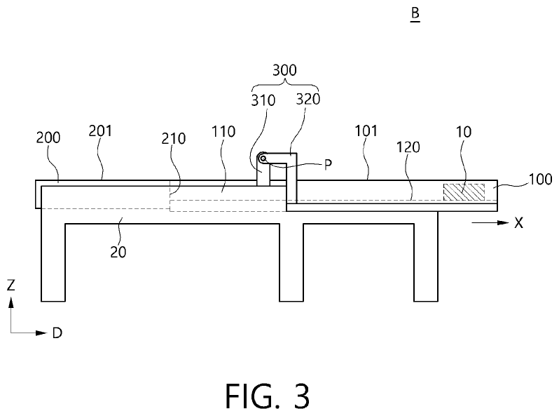

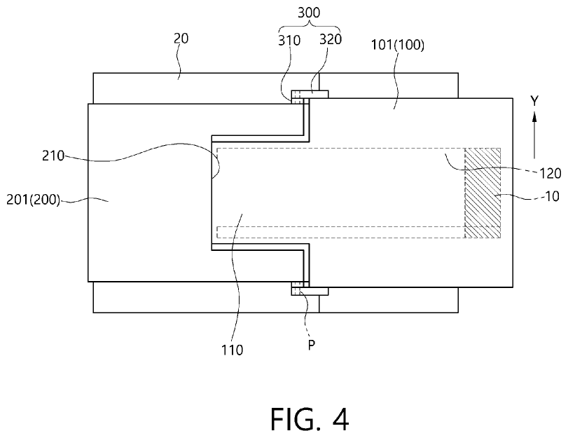

FIGS. 1 and 2 are a side view and a plan view, respectively, showing a use state-switchable massage device according to an embodiment of the present disclosure in a sitting state in which a user sits and uses it; and FIGS. 3 and 4 are a side view and a plan view, respectively, showing a use state-switchable massage device according to an embodiment of the present disclosure in a lying state in which a user lies down and uses it. Here, the direction X means a longitudinal direction of a backrest part and a seat part, the direction Y means a width direction of a backrest part and a seat part, the direction D means a front-rear direction, and the direction Z means a height direction based on the ground.

As shown in FIGS. 1 to 4, a use state-switchable massage device according to the present disclosure comprises: a backrest part 100 having a first support surface 101 for supporting a user's upper body, and a massage module 10 for massaging the user's upper body while moving along the first support surface 101, wherein the backrest part is rotatable so as to be switched between a first state (A) in which the user is sitting and a second state (B) in which the user is lying down; and a seat part 200 having a second support surface 201 for supporting the user's lower body; wherein the massage module is configured to massage the user's upper body in the case of the first state (A) and to massage the user's upper and lower body in the case of the second state (B).

The massage module 10 may perform a thermal massage on the user's body (particularly, the spine region). A hollow may be formed at the center of the backrest part 100 in the width direction Y so that the massage module 10 moves along the longitudinal direction X. The massage module 10 may have a separate moving means to perform massage while moving along the longitudinal direction X, and may have a rail member 120 as described later to provide a path for the massage module 10. The massage device may include a separate frame part 20 having leg members so that the backrest part 100 and the seat part 200 are spaced apart from the ground. In addition, the massage device may include a separate control part for controlling the rotation of the backrest part 100 and the operation of the massage module 10, wherein the control part controls the massage module 10 to massage the user's upper body in the first state (A), and controls the massage module 10 to massage the user's upper and lower body in the second state (B).

The backrest part 100 includes an extension member 110 formed to extend along the first support surface 101 so that the massage module 10 moves to the user's lower body in the second state (B). That is, in the first state (A) in which the user is sitting, the user's upper body (cervical spine, thoracic spine, lumbar spine) is massaged, whereas in the second state (B) in which the user is lying down, the massage module 10 massages the user's upper body (cervical spine, thoracic spine, lumbar spine) to lower body (coccyx spine, sacral spine) by the extension member 110.

In this case, in order to maximize the massage effect in the second state (B), the user may need to be able to lie down in a state in which the user's waist is fully stretched (a state in which the spine is straightened while being curved upward). To this end, the seat part 200 includes an insertion groove 210 into which the aforementioned extension member 110 is inserted in the second state (B). That is, in the process of rotating the backrest part 100 to switch the use state from the first state (A) to the second state (B), the extension member 110 formed to extend from the backrest part 100 is inserted into the insertion groove 210 of the seat part 200, whereby interference between the backrest part 100 and the seat part 200 does not occur, so that the backrest part 100 and the seat part 200 can be fully unfolded. As an example, when the backrest part 100 and the seat part 200 are completely unfolded, the angle formed between the backrest part 100 and the seat part 200 may be 180°. In the second state (B), when the backrest part 100 and the seat part 200 are arranged as described above, the user's waist is fully stretched, and thus, chiropractic and a traction operation to lift the user's spine are performed by the massage module 10, thereby maximizing a massage effect.

Meanwhile, in the first state (A), the extension member 110 formed to extend from the backrest part 100 may be configured to be positioned below the seat part 200 in the height direction Z. In this configuration, structural stability can be secured as the position of the center of gravity of the massage device is lowered in the first state (A). Further, since the rest of the backrest part 100 excluding the extension member 110 only needs to support the user's upper body (cervical spine, thoracic spine, and lumbar spine), the length of the backrest part 100 is shortened, and thus the rotation radius of the upper end of the backrest part 100 is reduced, whereby movement of the center of gravity of the massage device is minimized in the process of switching from the first state (A) to the second state (B), so that structural stability can be secured.

As shown in FIGS. 1 to 4, in the case of the first state (A), the first support surface 101 and the second support surface 201 may be arranged to be inclined so as to form a first slope with each other, and in the case of the second state (B), the first support surface 101 and the second support surface 201 may be arranged on the same line. That is, in the first state (A), since the user sits down and receives a massage, the backrest part 100 is erected at a certain angle so as to support the user's upper body (cervical spine, thoracic spine, and lumbar spine), and as a result, the first support surface 101 provided on the backrest part 100 and the second support surface 201 provided on the seat part 200 form a first slope Θ1. For example, the first slope Θ1 may be formed at an angle of 90° or more and less than 180° so that the user can sit in a comfortable posture and receive a massage, and may be changed within the above angle range according to the user's selection when used. In this case, the extension member 110 extending from the backrest part 100 is disposed below the seat part 200 in the height direction Z.

In addition, in the second state (B), the backrest part 100 rotates so that the user can lie down and receive a massage, wherein in the process of rotating the backrest part 100, the extension member 110 moves upward and is inserted into the insertion groove 210 of the seat part 200 to support the user's lower body (coccyx spine, sacral spine). In this case, the backrest part 100 and the seat part 200 may be arranged so that the user's waist can be fully stretched (the spine can be straightened while being curved upward), and to this end, the first support surface 101 and the second support surface 201 may be disposed on the same line. That is, the first support surface 101 and the second support surface 201 are arranged such that an angle of 180° is formed therebetween. When the first support surface 101 and the second support surface 201 are arranged as described above, the user's waist is fully stretched, and thus, chiropractic and a traction operation to lift the user's spine are performed by the massage module 10, thereby maximizing a massage effect. Meanwhile, in the second state (B), the first support surface 101 and the second support surface 201 may be disposed parallel to the ground, but are not necessarily limited thereto, and may also be disposed at an angle to the ground as long as the first support surface 101 and the second support surface 201 can be disposed on the same line.

As shown in FIGS. 1 to 4 , each of the backrest part 100 and the extension member 110 may be provided with a rail member 120 extending along the moving direction of the massage module 10. Therefore, when massaging the user's upper body in the first state (A), the massage module 10 moves in the longitudinal direction X along the rail member 120 provided on the backrest part 100 while massaging the user's upper body (cervical spine, thoracic spine, and lumbar spine), whereas when massaging the user's upper and lower body in the second state (B), the massage module 10 moves in the longitudinal direction along the rail member 120 provided on the backrest part 100 and the rail member 120 provided on the extension member 110 while massaging the user's upper body (cervical spine, thoracic spine, lumbar spine) and lower body (coccyx spine, sacral spine). To this end, the rail members 120 may be provided on the backrest part 100 and the extension member 110, respectively, wherein each of the rail members 120 may be arranged to be interconnected so that the massage module 10 can continuously move from the cervical spine to the sacral spine. Alternatively, it is also possible to arrange an integral rail member 120 on the backrest part 100 and the extension member 110. When the rail members 120 are provided on the backrest part 100 and the extension member 110, respectively, and are connected to each other, or the integral rail member 120 is disposed on the backrest part 100 and the extension member 110 as described above, the massage module 10 can perform continuous massage from the cervical spine to the sacral vertebrae in the second state, and the user's satisfaction is improved by removing a sense of heterogeneity which may be felt in the process of moving the massage module to the extension member.

In addition, as described above, in the process of switching the use state from the first state (A) to the second state (B), the extension member 110 of the backrest part 100 is inserted into the insertion groove 210 of the seat part 200, and thus, the rail member 120 provided in the extension member 110 is also inserted into the insertion groove 210. When configured in this way, the position in the height direction Z at which the massage module 10 moves in the second state (B) becomes constant. That is, since a reference position, which is a position in the height direction Z of the massage module 10, becomes constant, it is easy to control the position in the height direction Z of thermal ceramics provided in the massage module even when said position of the thermal ceramics needs to be adjusted for customized massage according to the user's body shape. Further, even in the case of designing a mechanism a mechanism such as a guide rail for raising the thermal ceramics, since the reference position is constant, the mechanism can be designed based on the same height direction Z position in all sections formed along the longitudinal direction X of the backrest part 100.

As shown in FIGS. 1 to 4, the massage device may further include a hinge part 300 for hingedly fixing the backrest part 100 so that the backrest part 100 can rotate about a hinge point P spaced upward from the second support surface 201. That is, the hinge point P, which is the center of rotation of the backrest part 100, is formed at a position spaced upward from the second support surface 201 of the seat part 200. For example, the hinge point P may be disposed on an extension line in the width direction Y from the position of the user's hip joint. In this configuration, the state in which the first support surface 101 supports the user is maintained constant even when the backrest part 100 is rotated in the process of switching the use state from the first state (A) to the second state (B), and therefore, the user's satisfaction is improved by eliminating the inconvenience that may be felt when the use state is switched. This hinge part 300 may be provided in a separate frame part 20.

As shown in FIGS. 1 to 4, the hinge part 300 may include: a first support bar 310 extending upward from the second support surface 201 so that the hinge point P is disposed at a position spaced upward therefrom; and a second support bar 320 connecting the hinge point P and the backrest part 100 so that the backrest part 100 can rotate about the hinge point P. That is, in a state in which the hinge point P is disposed at a position upwardly spaced from the second support surface 201 through the first support bar 310 and the second support bar 320, the backrest part 100 can be stably rotated.

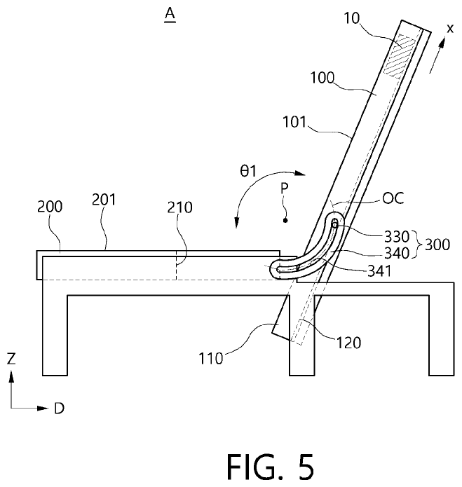

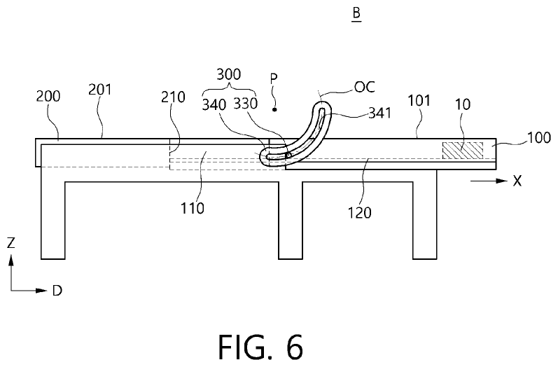

FIG. 5 is a side view showing a use state-switchable massage device according to another embodiment of the present disclosure in a sitting state in which a user sits and uses it, and FIG. 6 is a side view showing a use state-switchable massage device according to another embodiment of the present disclosure in a lying state in which a user lies down and uses it.

As shown in FIGS. 5 and 6, the hinge part 300 may include a first guide bar 330 provided in the backrest part 100 and a first guide plate 340 provided in the seat part 200 and having a first guide hole 341 providing a movement path of the first guide bar 330, wherein the first guide hole 341 may be configured to have the same curvature as a concentric circle (OC) centered on the hinge point P. That is, the first guide hole 341 provided in the first guide plate 340 so that the backrest part 100 rotates around a virtual hinge point P is formed to have the same curvature as a concentric circle (OC) centered on the virtual hinge point P; and the backrest part 100 is configured to rotate while the first guide bar 330 provided in the backrest part 100 moves along the first guide hole 341 in the state where the first guide bar 330 is inserted into the first guide hole 341. This virtual hinge point P may also be disposed on the extension line in the width direction Y from the user's hip joint position, and the user does not feel uncomfortable even when the backrest part 100 is rotated according to the change in use state.

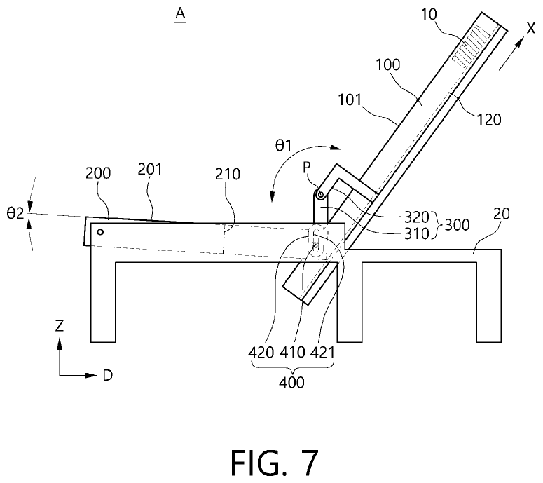

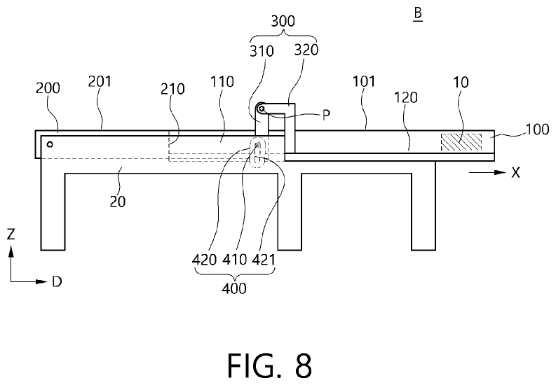

FIG. 7 is a side view showing a use state-switchable massage device according to still another embodiment of the present disclosure in a sitting state in which a user sits and uses it (seat part is rotated), and FIG. 8 is a side view showing a use state-switchable massage device according to still another embodiment of the present disclosure in a lying state in which a user lies down and uses it (seat part is rotated).

As shown in FIGS. 7 and 8 , the massage device may further include a tilting part 400 for rotating the seat part 200 so that a second slope Θ2 is formed on the seat part 200. That is, the seat part 200 is configured to be rotatable by the tilting part 400, so that the user can receive a massage in a comfortable posture suitable for a sitting state or a lying state in which the user uses. The second slope Θ2 formed on the seat part 200 may be formed at an angle between about 5° and 10°, but this may be changed according to product design specifications.

In the case of the first state (A), the tilting part 400 may rotate the seat part 200 so that the rear of the seat part 200 is positioned at a lower position than the front of the seat part 200 and thus the seat part 200 is inclined upward; and in the case of the second state (B), the tilting part 400 may rotate the seat part 200 so that the front and rear portions of the seat part 200 are positioned at the same height, and thus the seat part 200 is horizontally arranged. For example, the position of the seat part 200 in the height direction Z may be a position spaced apart from the ground. That is, in the case of the first state (A) in which the user sits and uses, the front of the seat part 200 is disposed at a relatively higher position than the rear thereof, thereby giving the user a sense of stability; and in the case of the second state (B) in which the user lies down and uses, the seat part 200 is positioned horizontally so that the user can receive a massage in a comfortable state.

To this end, the tilting part 400 may include a second guide bar 410 provided at the rear of the seat part 200 and a second guide plate 420 provided with a second guide hole 421 providing a movement path for the second guide bar 410, wherein the second guide hole 421 may be formed along the height direction Z so that the rear of the seat part 200 moves in the height direction Z. In this case, the front of the seat part 200 may be provided with a reference point at which the seat part 200 rotates, and the rear of the seat part 200 moves along the height direction Z around this reference point. The second guide plate 420 having the second guide hole 421 may be provided in the frame part 20, wherein the second guide bar 410 provided at the rear of the seat part 200 is rotated while being inserted into the second guide hole 421, thereby improving structural stability.

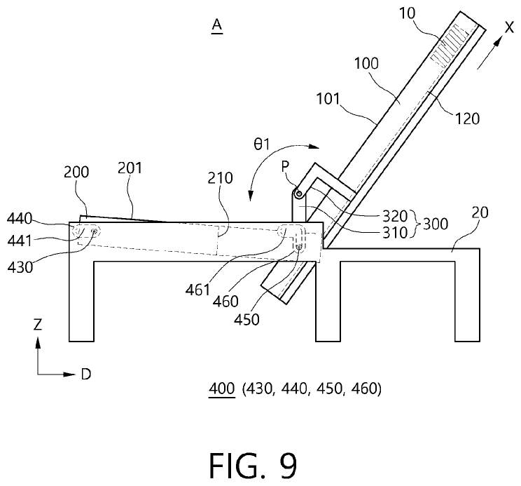

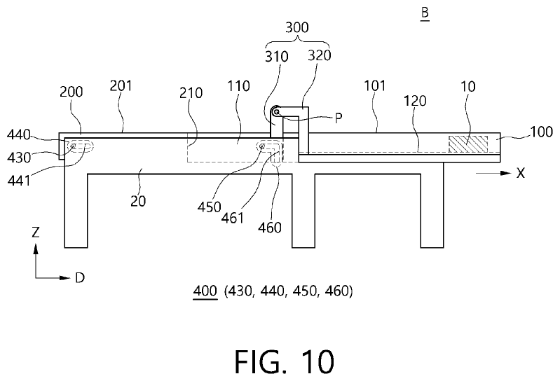

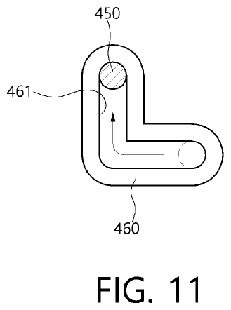

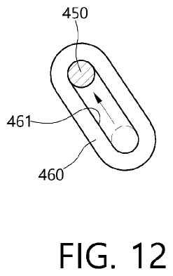

FIG. 9 is a side view showing a use state-switchable massage device according to still another embodiment of the present disclosure in a sitting state in which a user sits and uses it (seat part is rotated and moved forward); FIG. 10 is a side view showing a use state-switchable massage device according to still another embodiment of the present disclosure in a lying state in which a user lies down and uses it (seat part is rotated and moved forward); and FIGS. 11 and 12 are side views illustrating various embodiments of a fourth guide plate provided in a use state-switchable massage device according to still another embodiment of the present disclosure.

As shown in FIGS. 9 and 10, the tilting part 400 described above may include a third guide bar 430 provided at the front of the seat part 200, a third guide plate 440 provided with a third guide hole 441 providing a movement path for the third guide bar 430, and a fourth guide bar 450 provided at the rear of the seat part 200, and a fourth guide plate 460 provided with a fourth guide hole 461 providing a movement path for the fourth guide bar 450, wherein the third guide hole 441 may be formed along an front-rear direction D so that the front of the seat part 200 moves in the front-rear direction D, and wherein the fourth guide hole 461 may be formed along the height and front-rear directions Z and D so that the rear of the seat part 200 moves in the height and front-rear directions Z and D. As described above, the seat part 200 is configured to rotate according to the first state (A) or the second state (B), whereby the user can receive a massage in a comfortable and stable posture; and further, considering that the user's lower body is pushed forward in the process of switching the backrest part 100 to the second state (B), the seat part 200 is configured to be movable along the front-rear direction D. With this configuration, the user's lower body can be stably supported by the seat part 200 even if the user's lower body is moved in the front-rear direction D by the backrest part 100 in the process of switching the use state.

Here, the fourth guide plate 460 provided at the rear of the seat part 200 may need to stably support the user while the rear of the seat part 200 moves in the height direction Z and the front-rear direction D. To this end, as shown in FIGS. 9 and 10, the fourth guide hole 461 provided in the fourth guide plate 460 may be configured so that in the process of switching to the second state (B), the rear of the seat part 200 is moved in the height direction Z (the seat part is tilted), and then the seat part 200 is moved forward. Alternatively, as shown in FIG. 11, it may be configured so that in the process of switching to the second state (B), the seat part 200 first moves forward and then the rear of the seat part 200 moves in the height direction Z (the seat part is tilted). Still alternatively, as shown in FIG. 12, it may be configured so that the rear of the seat part 200 moves in the front-rear direction D simultaneously with the movement in the height direction Z.

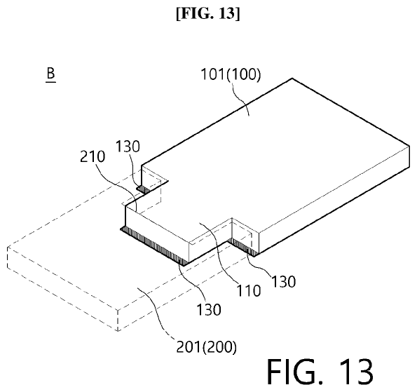

FIG. 13 is a perspective view showing a use state-switchable massage device according to still another embodiment of the present disclosure in a lying state in which a user lies down and uses it (structure in which the backrest part lifts the seat part).

As shown in FIG. 13, in the process of rotating the backrest part 100 to switch from the first state (A) to the second state (B), the lower end of the backrest part 100 may move upward while lifting the rear end of the seat part 200 so that the seat part 200 is horizontally disposed. That is, in the first state (A), the rear of the seat part 200 is located at a lower position than the front of the seat part 200, so that the seat part 200 is inclined upward. In order to switch from the above-mentioned first state (A) to the second state (B), the seat part 200 needs to be arranged horizontally so that the front and rear positions of the seat part 200 in the height direction Z are the same. When the rear of the seat part 200 is configured to be lifted using the rotating backrest part 100 as described above, the seat part 200 can be horizontally arranged by simply lifting the rear of the seat part 200, even if a separate driving unit is not provided. In this case, a locking member 130 may be provided at the lower end of the backrest part 100 to support the rear end of the seat part 200 in the second state (B). That is, the seat part 200 is lifted by using the locking member 130, and when the user is lying down in the second state (B), the locking member 130 can maintain the level while supporting the user's load. The locking member 130 may also be provided at the lower end of the extension member 110, and in this case, the user's load applied to the locking member 130 in the second state (B) can be dispersed so that stable support is possible.

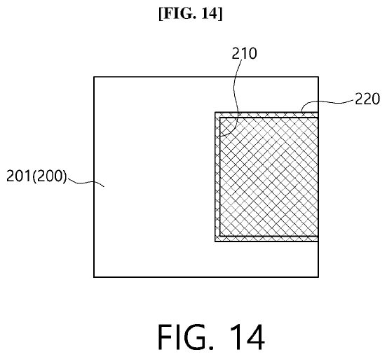

FIG. 14 is a plan view illustrating a cover member provided in a use state-switchable massage device according to still another embodiment of the present disclosure.

As shown in FIG. 14, the seat part 200 may include a cover member 220 for supporting the user's lower body to prevent the user's lower body from falling into the insertion groove 210 in the first state (A). A mesh-type cover can be used as the cover member 220, wherein in the second state (B), the massage module 10 is configured to massage the user's lower body through the cover member 220.

As described above, in the process of rotating the backrest part 100 to switch the use state from the first state (A) to the second state (B), the extension member 110 formed to extend from the backrest part 100 is inserted into the insertion groove 210 of the seat part 200, whereby interference between the backrest part 100 and the seat part 200 does not occur, so that the backrest part 100 and the seat part 200 can be fully unfolded. Therefore, the user's waist is fully stretched, and thus, chiropractic and a traction operation to lift the user's spine are performed by the massage module 10, thereby maximizing a massage effect. In addition, in the first state (A), the extension member 110 extending from the backrest part 100 is located below the seat part 200 in the height direction Z, whereby structural stability can be secured as the position of the center of gravity of the massage device is lowered in the first state (A). Further, since the rest of the backrest part 100 excluding the extension member 110 only needs to support the user's upper body (cervical spine, thoracic spine, and lumbar spine), the length of the backrest part 100 is shortened, and thus the rotation radius of the upper end of the backrest part 100 is reduced, whereby movement of the center of gravity of the massage device is minimized in the process of switching from the first state (A) to the second state (B), so that structural stability can be secured.

Although an embodiment of the present disclosure have been described above, the spirit of the present disclosure is not limited to the embodiment presented in the subject specification; and those skilled in the art who understands the spirit of the present disclosure will be able to easily suggest other embodiments through addition, changes, elimination, and the like of elements without departing from the scope of the same spirit, and such other embodiments will also fall within the scope of the present disclosure.

What is claimed is:

1. A use state-switchable massage device comprising:
a backrest part having a first support surface for supporting a user's upper body, and a massage module for massaging the user's upper body while moving along the first support surface, wherein the backrest part is rotatable so as to be switched between a first state in which the user is sitting and a second state in which the user is lying down; and
a seat part having a second support surface for supporting the user's lower body;
wherein the massage module is configured to massage the user's upper body in the case of the first state and to massage the user's upper and lower body in the case of the second state;
wherein the backrest part includes an extension member formed to extend along the first support surface so that the massage module moves to the user's lower body in the case of the second state; and
wherein the seat part includes an insertion groove into which the extension member is inserted in the case of the second state.

2. The use state-switchable massage device according to claim 1, wherein in the case of the first state, the first support surface and the second support surface are be arranged to be inclined so as to form a first slope with each other, and
in the case of the second state, the first support surface and the second support surface are arranged on the same line.

3. The use state-switchable massage device according to claim 1, wherein each of the backrest part and the extension member is provided with a rail member extending along a moving direction of the massage module.

4. The use state-switchable massage device according to claim 1, wherein the massage device further includes a hinge part for hingedly fixing the backrest part so that the backrest part can rotate about a hinge point spaced upward from the second support surface.

5. The use state-switchable massage device according to claim 4, wherein the hinge part includes:
a first support bar extending upward from the second support surface so that the hinge point is disposed at a position spaced upward therefrom; and
a second support bar connecting the hinge point and the backrest part so that the backrest part can rotate about the hinge point.

6. The use state-switchable massage device according to claim 4, wherein the hinge part includes:
a first guide bar provided in the backrest part; and
a first guide plate provided in the seat part and having a first guide hole providing a movement path of the first guide bar,
wherein the first guide hole has the same curvature as a concentric circle centered on the hinge point.

7. The use state-switchable massage device according to claim 1, wherein the massage device further includes a tilting part for rotating the seat part so that a second slope is formed on the seat part.

8. The use state-switchable massage device according to claim 7, wherein in the case of the first state, the tilting part rotates the seat part so that the rear of the seat part is positioned at a lower position than the front of the seat part and thus the seat part is inclined upward; and
in the case of the second state, the tilting part rotates the seat part so that the front and rear portions of the seat part are positioned at the same height and thus the seat part is horizontally arranged.

9. The use state-switchable massage device according to claim 8, wherein the tilting part may include:
a second guide bar provided at the rear of the seat part; and
a second guide plate provided with a second guide hole providing a movement path of the second guide bar,
wherein the second guide hole is formed along a height direction so that the rear of the seat part moves in the height direction.

10. The use state-switchable massage device according to claim 8, wherein the tilting part includes:
a third guide bar provided at the front of the seat part;
a third guide plate provided with a third guide hole providing a movement path for the third guide bar;
a fourth guide bar provided at the rear of the seat part; and
a fourth guide plate provided with a fourth guide hole providing a movement path for the fourth guide bar;
wherein the third guide hole is formed along a front-rear direction so that the front of the seat part moves in the front-rear direction; and
wherein the fourth guide hole is formed along the height and front-rear directions so that the rear of the seat part moves in the height and front-rear directions.

11. The use state-switchable massage device according to claim 1, wherein in the process of rotating the backrest part to switch from the first state to the second state, the lower end of the backrest part moves upward while lifting the rear end of the seat part so that the seat part is arranged horizontally.

12. The use state-switchable massage device according to claim 11, wherein the lower end of the backrest part is provided with a locking member supporting the rear end of the seat part in the second state.

13. The use state-switchable massage device according to claim 1, wherein the seat part includes a cover member supporting the user's lower body to prevent it from falling into the insertion groove in the first state.
